(19) United States
(12) Patent Application Publication
(10) Pub. No.: US 2025/0224349 A1
(43) Pub. Date: Jul. 10, 2025

(54) Inspection Method and Inspection Device

(71) Applicant: SHIMADZU CORPORATION, Kyoto-shi (JP)

(72) Inventor: Koichi TANABE, Kyoto-shi (JP)

(21) Appl. No.: 18/965,503

(22) Filed: Dec. 2, 2024

(30) Foreign Application Priority Data
Dec. 1, 2023 (JP) 2023-204223

(51) Int. Cl. G01N 23/18; G01N 23/046

(52) U.S. Cl. CPC G01N 23/18; G01N 23/046; G01N 2223/1016; G01N 2223/401; G01N 2223/408; G01N 2223/422

(57) ABSTRACT

An image generator built by machine learning is stored in an image-generator storage section (31). The image generator receives an image having a missing region and fills that region with a complementary image. An inspection target image is stored in an image storage section (32). A missing-image generator (44) generates, from the inspection target image, a missing image (63) in which a region is missing, a window (62) having a specified shape and size being applied on the region. A complemented-image generator (45) generates a complemented image (65) having the region filled with a complementary image by inputting the missing image into the image generator. A difference acquirer (46) determines a difference (66) between the inspection target image and the complemented image. A determiner (47) determines whether the region is normal or abnormal by comparing the difference with a predetermined criterion.

### TECHNICAL FIELD

The present invention relates to an inspection technique for determining whether an inspection target object is normal or abnormal based on an image in which the inspection target object is photographed.

### BACKGROUND ART

When a product manufactured in a plant is to be shipped, a pre-shipment inspection for confirming that there is no abnormality in the product is performed. In this type of inspection, for example, an inspector determines whether the product is normal or abnormal (quality check) by visually examining an image in which the product is photographed to check for a defect portion included in the product or a foreign object mixed in the product. However, when an inspector visually inspects images of a large number of products manufactured in a plant, various problems occur, such as the overlooking of defective products, the considerable cost of labor, and the limited speed of inspection.

To address this problem, attempts have been made to perform the quality check of an inspection target product from an image of the product by using, as a discriminator, a trained model built by machine learning which uses, as teaching data, a large number of images of products which have already been judged to be normal or abnormal.

### CITATION LIST

### Non Patent Literature

Non Patent Literature 1: “AI Wo Mochiita Furyouhin Gazou Seisei Gijutsu Wo RUTILEA Ga Kaihatsu—Gaikan Kensa No Kyoushi-you Gazou No Fusoku Wo Kaiketsu Shimasu (RUTILEA develops an AI-based technique for creating images of defective products—A solution to the lack of teaching images for appearance test)”, [online], May 11, 2023, RUTILEA, Inc., [accessed on Nov. 10, 2023], the Internet <URL: https://rutilea.com/info/2278/>

Non Patent Literature 2: “Train Generative Adversarial Network (GAN)”, [online], The Math Works, Inc., [accessed on Nov. 13, 2023], the Internet <URL: https://www.mathworks.com/help/deeplearning/ug/train-generative-adversarial-network.html>

Non Patent Literature 3: “Gazou Seisei AI No Shikumi [Kouhen] AI No Efude Ha Donna Katachi? ‘Gazou Seiseiki’ Ni Tsuite Shiru (How image generative AIs work [Part 2], What shape do Al's paintbrushes have? Learn about ‘image generators’)”, Mar. 30, 2023, Gijutsu-Hyoron Co., Ltd., [accessed on Nov. 13, 2023], the Internet <URL: https://gihyo.jp/article/2023/03/how-ai-image-generator-work-02>

### SUMMARY OF INVENTION

### Technical Problem

Since the mode of abnormalities which occur in products is not uniform, the accuracy of a discriminator using a trained model built by machine learning depends on the variations of the teaching data used for the machine learning, or more specifically, on the variations of abnormal portions to be discriminated. In order to deal with a wide variety of modes of abnormalities, it is necessary to perform the machine learning using, as the teaching data, images of products having an even wider variety of modes of abnormalities including the aforementioned ones. In general, most of the products manufactured in a plant are normal, and therefore, it is difficult to obtain images of products having various modes of abnormalities. Although it is possible to prepare products in which various modes of abnormalities are intentionally provided, or to use a dedicated software application for creating images of products having abnormalities as described in Non Patent Literature 1, those tasks require a considerable amount of time, labor and cost.

Although the description thus far has been concerned with the case of inspecting products manufactured in a plant, the previously described problems similarly occur in the case of determining the normality or abnormality of inspection target objects which are not industrial products.

The problem to be solved by the present invention is to reduce the amount of time, labor and cost for determining whether an inspection target object is normal or abnormal.

### Solution to Problem

An inspection method according to one mode of the present invention developed for solving the previously described problem includes:
an image generator preparation process for preparing an image generator by machine learning, the image generator configured to generate, from an image having a partially missing region, an image in which the missing region is filled with a complementary image;
an inspection-image preparation process for preparing an inspection target image;
a missing-image generation process for specifying a window having a previously determined shape and size, and for generating, from the inspection target image, a missing image in which a region is missing, the window being applied on the region;
a complemented-image generation process for generating a complemented image in which the region is filled with a complementary image by inputting the missing image into the image generator;
a difference acquisition process for determining a difference between the inspection target image and the complemented image; and
a determination process for determining whether the region is normal or abnormal by comparing the difference with a previously determined criterion.

An inspection device according to another mode of the present invention developed for solving the previously described problem includes:
an image-generator storage section in which an image generator built by machine learning is stored, the image generator configured to generate, from an image having a partially missing region, an image in which the missing region is filled with a complementary image;
an image storage section in which an inspection target image is stored;
a missing-image generator configured to generate, from the inspection target image, a missing image in which a region is missing, a window having a previously specified shape and size being applied on the region;
a complemented-image generator configured to generate a complemented image in which the region is filled with a complementary image by inputting the missing image into the image generator;
a difference acquirer configured to determine a difference between the inspection target image and the complemented image; and
a determiner configured to determine whether the region is normal or abnormal by comparing the difference with a previously determined criterion.

### Advantageous Effects of Invention

In the present invention, an image generator configured to generate, from an image having a partially missing region, an image in which the missing region is filled with a complementary image is prepared beforehand by machine learning. The image generator used in the present invention is a so-called image generative AI and has the function of filling a missing region in an image by an appropriate method, e.g., by deducing a normal image to be included in the missing region from an image of a surrounding area of the missing region. This image generator is built by machine learning using images of normal objects (preferably, inspection target objects) and fills the missing region of an inspection target image with an image of a normal object (inspection target object).

In the present invention, a window having a previously determined shape and size is specified, and the window is applied to an image of an inspection target object (inspection target image) and its inner region is removed. A complementary image for filling that removed region (missing region) is created by the image generator. As noted earlier, the image generator fills the missing region with a complementary image of a normal inspection target object. Therefore, no significant difference occurs between the inspection target image and the complemented image if the inspection target image is an image of a normal inspection target object. Conversely, when an abnormality is included within the window-applied region of the inspection target image, a significant difference occurs in that region when a difference between the inspection target image and the complemented image (e.g., the difference of each pixel value) is determined. By extracting such a significant difference based on the previously determined criterion, it is concluded that an abnormality is included within the window-applied region.

Conventional techniques employ a discriminator in order to determine whether or not an abnormality is included in an inspection target image. Therefore, in order to discriminate between normality and abnormality of an inspection target object with a high level of accuracy, it is necessary to perform machine learning using, as training data, a huge number of images of inspection target objects including various modes of abnormalities. By comparison, the present invention employs an image generator which fills a missing region within a window applied to an inspection target image with an image of a normal inspection target. Whether or not an abnormality is included in the inspection target image is determined by a simple process in which the difference between pixel values of the inspection target image and the corresponding pixel values of the complemented image is compared with a previously determined criterion. This process does not require a discriminator. The present invention uses an image generator built by machine learning using images of normal objects. As compared to the discriminator conventionally used for discriminating between normality and abnormality of an inspection target object based on an image of the same object, the aforementioned image generator can be built with a smaller amount of time, labor and cost and yet enables the determination on whether the inspection target object is normal or abnormal.

### BRIEF DESCRIPTION OF DRAWINGS

FIG. 1 A configuration diagram of the main components of an inspection system including one embodiment of the inspection device according to the present invention.

FIG. 2 A diagram illustrating the configuration of a generative adversarial network.

FIG. 3 A flowchart illustrating one embodiment of the inspection method according to the present invention.

FIG. 4 A diagram illustrating the setting of the window in the present embodiment.

FIG. 5 A diagram illustrating a missing image, complemented image and difference image in the present embodiment.

FIG. 6 A preprocessed image in an inspection example of a storage battery.

FIG. 7 Preprocessed images of a storage battery taken before and after a charge-and-discharge test.

FIG. 8 A preprocessed image, missing image, complemented image and difference image in an inspection example of a storage battery.

FIG. 9 A preprocessed image, missing image, complemented image and difference image in another inspection example of a storage battery.

### DESCRIPTION OF EMBODIMENTS

An embodiment of the inspection method and the inspection device according to the present invention is hereinafter described with reference to the drawings.

### Configuration of Inspection System 1

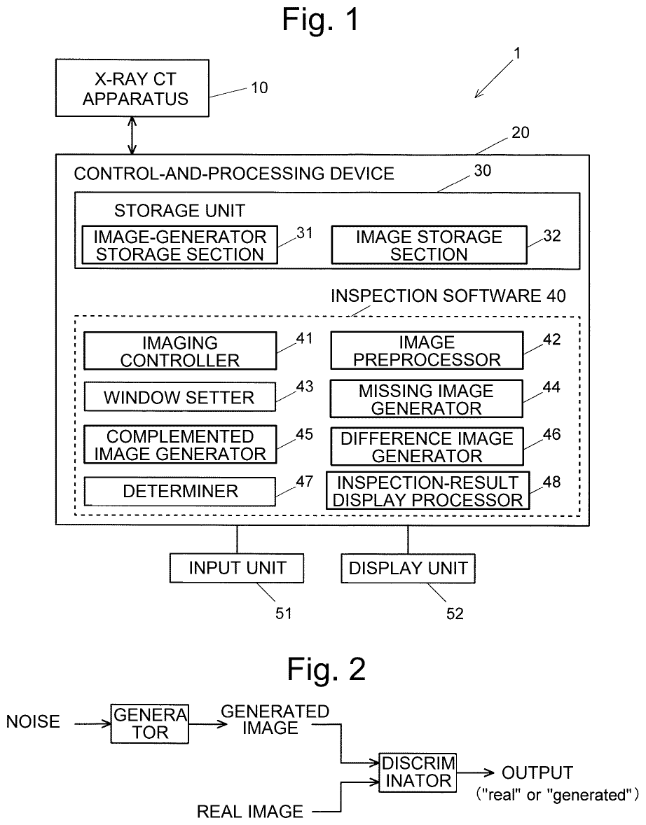

FIG. 1 shows the configuration of the main components of an inspection system 1 including the inspection device according to the present embodiment. The inspection system 1 in the present embodiment includes an X-ray CT apparatus 10 and a control-and-processing device 20. The control-and-processing device 20 corresponds to one embodiment of the inspection device according to the present invention.

The X-ray CT apparatus 10 irradiates an inspection target object with X-rays and takes a tomographic image of the inside of the object. The X-ray CT apparatus 10 can also perform dual-energy imaging in which the object is irradiated with X-rays with a plurality of different energy levels and a tomographic image is taken at each energy level.

The control-and-processing device 20 includes a storage unit 30. The storage unit 30 has an image-generator storage section 31 in which an image generator built by a trained model created by machine learning is to be stored, and an image storage section 32 in which tomographic images of an inspection target object taken with the X-ray CT apparatus 10 are to be stored. The storage unit 30 also holds information to be used as a criterion for determining, from an image of an inspection target object, whether the inspection target object is normal or abnormal (in the present embodiment, a threshold of the standard deviation of the pixel values of the pixels forming a difference image 65 (see FIG. 5, which will be described later)). This criterion can be determined based on values obtained by performing a series of processes (which will be described later) using images of one or more normal inspection target objects as inspection target images.

The control-and-processing device 20 also includes an imaging controller 41, image preprocessor 42, window setter 43, missing-image generator 44, complemented-image generator 45, difference image acquirer 46, determiner 47 and inspection result display processor 48 as its functional blocks. For example, the control-and-processing device 20 can be constructed using a common personal computer, with the aforementioned functional blocks embodied by executing, on a processor, a program of dedicated inspection software 40 previously installed on the computer. Additionally, an input unit 51 including a keyboard, mouse and/or other devices, as well as a display unit 52 including a liquid crystal display and/or other devices, are connected to the control-and-processing device 20.

In the present embodiment, an image generator is prepared and stored in the image-generator storage section 31 before the process of determining the normality or abnormality of inspection target objects based on an image of the same object is performed. The image generator in the present embodiment is built by generative adversarial networks (GANs), which are a technique of unsupervised machine learning in which the learning of features is performed without using labeled training data. For example, as described in Non Patent Literature 2, the generative adversarial network itself is a conventionally known technique. Therefore, only a brief description is hereinafter given.

FIG. 2 shows the structure of a generative adversarial network. The generative adversarial network has two neural networks, one of which is a generator, which receives an input of a vector of random values (potential input) and generates data having the same structure as the learning data. The other is a discriminator, which receives a batch of data including observed values of both the learning data and the data generated by the generator and attempts to classify the observed values into the group of “real” or “generated” values.

In the training of a GAN, it is normal to simultaneously perform the training of both networks to maximize the performance of the two networks. Specifically, the machine learning performed by the generator is such that the generator receives an input of noise corresponding to the seeds of the features of generated data and performs the mapping to make this noise approximate to desired data and generate data which the discriminator will judge to be real. The machine learning performed by the discriminator is intended to create a discriminator which will identify an image generated by the generator as a real image. In this machine learning, it is preferable that the generator should generate, as generated data, an image of the same kind of object as the inspection target object. This enables the creation of a generator which has learned the features of inspection target objects in a greater amount. Since the aim of the present GAN learning is to build an image generator configured to generate images of normal inspection objects, it is unnecessary to perform machine learning related to images of abnormal inspection target objects as in the case of creating a conventionally used discriminator. Furthermore, in the present embodiment, only the generator created through the GAN training is required as the image generator; it is unnecessary to perform the machine learning of the discriminator. Therefore, in the present embodiment, a discriminator having a certain level of discrimination ability may be used in its original form (without additional machine learning), and the machine learning using the GAN may be performed only for the generator.

### Inspection Method Using Inspection System 1

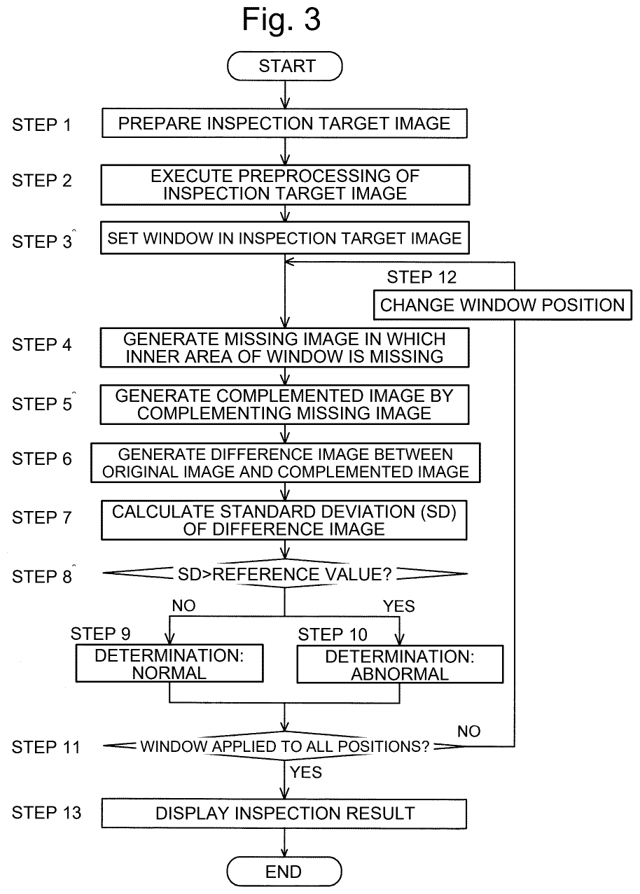

Next, a procedure for determining the normality or abnormality of an inspection target object using the inspection device according to the present embodiment is described with reference to the flowchart of FIG. 3.

The user initially prepares a tomographic image of an inspection target object (inspection target image) (Step 1). If tomographic images have already been acquired, a tomographic image of the inspection target object is read from the image storage section 32. If no tomographic image has been acquired yet, the user sets the inspection target object at a predetermined position in the X-ray CT apparatus 10 and issues a command for taking images. In response to the command for taking tomographic images, the imaging controller 41 irradiates the object with X-rays with a plurality of different energy levels and takes a tomographic image at each energy level. The taken tomographic images are related to a piece of information which identifies the inspection target object (e.g., ID number) and are stored in the image storage section 32.

Next, the image preprocessor 42 performs a previously determined preprocessing on the tomographic images of the inspection target object (Step 2). For example, the preprocessing of an image includes the process of normalizing the size of each tomographic image and the process of removing artefacts from the image. The normalization of the size of a tomographic image is a process in which the numbers of pixels in the horizontal and vertical directions of the taken image are made to be equal to the previously determined numbers of pixels. The previously determined numbers of pixels should preferably be approximate to (preferably, equal to) the number of pixels of the images generated by the generator in the machine learning for building the used image generator. This helps the features learned by the image generator to be reflected in the process of generating a complemented image (which will be described later). The removal of artefacts is, for example, a process in which, based on the tomographic images obtained by irradiating an inspection target object with X-rays with a plurality of different energy levels, only a portion corresponding to the region to be inspected is extracted, and artefacts which are unique to images taken with the X-ray CT apparatus 10 are removed. For example, in the case of determining the normality or abnormality of the electrodes of a storage battery, the process includes distinguishing the electrodes from the other members and identifying the electrode portion and/or removing unnecessary portions from the plurality of tomographic images. It should be noted that the preprocessing of the image is not an essential process. However, performing such a preprocessing has the effect that a highly accurate generated image can be generated by the generator. It also prevents a false-positive determination due to an artefact in an image.

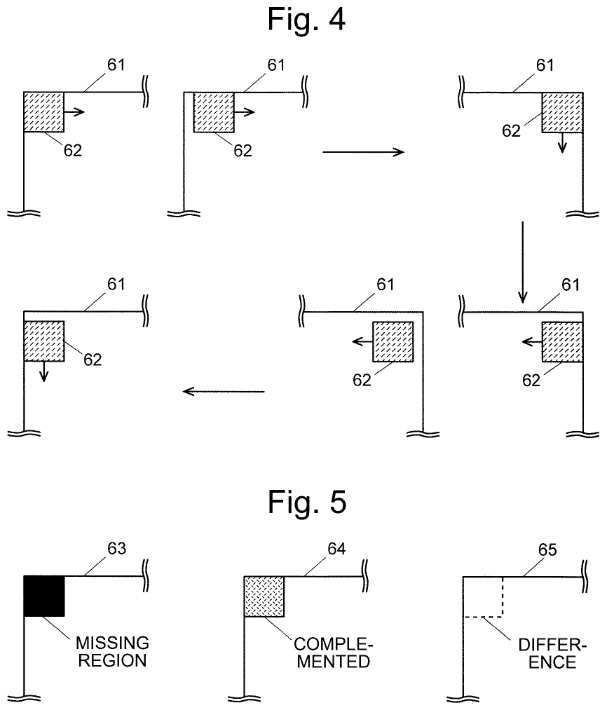

The window setter 43 subsequently sets a window 62 of a predetermined size at an initial position (e.g., the upper left corner) in an image obtained by the preprocessing (the preprocessed image 61) (Step 3; see the upper left panel in FIG. 4). The window 62 used in the present embodiment has a rectangular shape. The lengths of the two sides of the window 62 in the present embodiment are 10% of the lengths of the two sides of the preprocessed image, respectively.

After the window 62 has been set, the missing-image generator 44 generates a missing image 63 which is the preprocessed image 61 from which the pixel data of the portion indicated by the window 62 have been erased (Step 4; see FIG. 5).

After the missing image 63 has been generated, the complemented-image generator 45 generates a complemented image 64 by filling the missing region of the missing image 63 with a complementary image by using the image generator stored in the image-generator storage section 31 (Step 5; see FIG. 5).

After the complemented image 64 has been generated, the difference image acquirer 46 creates a difference image 65 which is the difference between the preprocessed image 61 and the complemented image 64 (Step 6; see FIG. 5).

After the difference image 65 has been created, the determiner 47 calculates the standard deviation of the difference image 65 (Step 7). Specifically, this calculation includes determining the difference in the pixel value at each pixel within the region on which the window is set in the difference image 65 and calculating the standard deviation of the difference values. The determiner 47 compares the calculated value of the standard deviation with the threshold stored in the storage section (Step 8). If the value of the standard deviation is not larger than the threshold (“NO” in Step 8), the determiner 47 concludes that the region to which the window 62 is applied is normal (Step 9). If the value of the standard deviation is larger than the threshold (“YES” in Step 8), the determiner 47 concludes that an abnormality is included within the region to which the window 62 is applied (Step 10).

After the completion of the determination on the normality or abnormality of the region to which the window 62 is applied, the window setter 43 determines whether or not the window 62 has been set at all positions in the preprocessed image 61 (Step 11). In the present situation, since the window 62 has only been set at the initial position, the window setter 43 concludes that there are positions at which the window 62 has not been set yet.

When it is concluded that there are positions at which the window 62 has not been set yet, the window setter 43 sets a new window 62 at a position displaced from the position at which the previous window 62 was set (in the present situation, the initial position) by a previously determined number of pixels in a previously determined direction (e.g. by one or a few pixels rightward) (Step 12). For example, as shown in FIG. 4, the window setter 43 sequentially repeats the setting of the window 62 within the preprocessed image 61 by a method called the “sliding window”, which is a technique used in object detection or similar technical areas. It should be noted that the present embodiment is concerned with the case where the location of an abnormality is unknown. When the location of an abnormality has been predicted, the user may specify the predicted region in place of the moving window and command the device to process only the specified region.

After the new window 62 has been set, the operation returns to Step 4 to once more perform the processing from Steps 4 through 11 in the previously described manner. In Step 11, when it is concluded that the window 62 has been set at all positions, the inspection result display processor 48 refers to the determination result for each of the windows 62 that have been set so far and displays, as the inspection result on the display unit 52, an image which is the preprocessed image 61 on which the position of the window 62 which has been judged to be including an abnormality is superposed (Step 13).

### FIRST EXAMPLE

As a specific example, the result of an inspection of the electrodes of a storage battery is hereinafter described. In the present example, an inspection concerning the presence or absence of an abnormality in the electrodes was performed using an image of a cylindrical lithium-ion battery (a roll of a layered sheet of positive electrode, separator and negative electrode enclosed in a cylindrical container; 18650 LIB) taken after a repetitive charge-and-discharge test had been performed. Once again, as in the previously described embodiment, the sliding window was used to sequentially set a window within a preprocessed image 61, and the presence or absence of an abnormality at each position of the window was determined by the previously described processing of Steps 4 through 10.

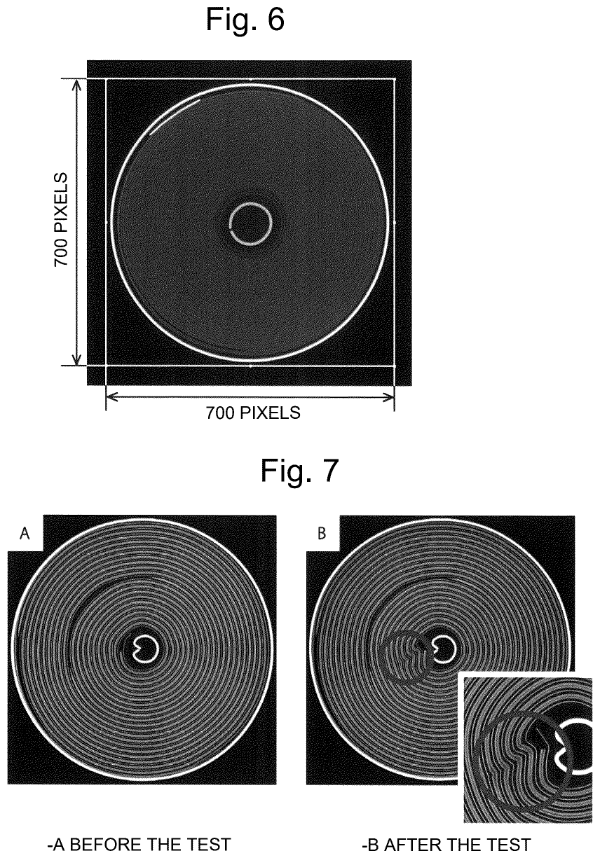

FIG. 6 shows the preprocessed image 61. For the present example, a preprocessed image 61 of 700×700 pixels was used, and a square window of 70×70 pixels was applied to the image. The left panel in FIG. 7 is a partially enlarged view of a tomographic image taken before the test (image A), while the right panel is a partially enlarged view of a tomographic image taken after the test (image B). An abnormality (wrinkle-like bend) of the electrodes is present at the location indicated by the circle in tomographic image B. It should be noted that, although the abnormality of the electrodes which occurred in the present example is wrinkle-like, abnormalities of electrodes can occur in various forms.

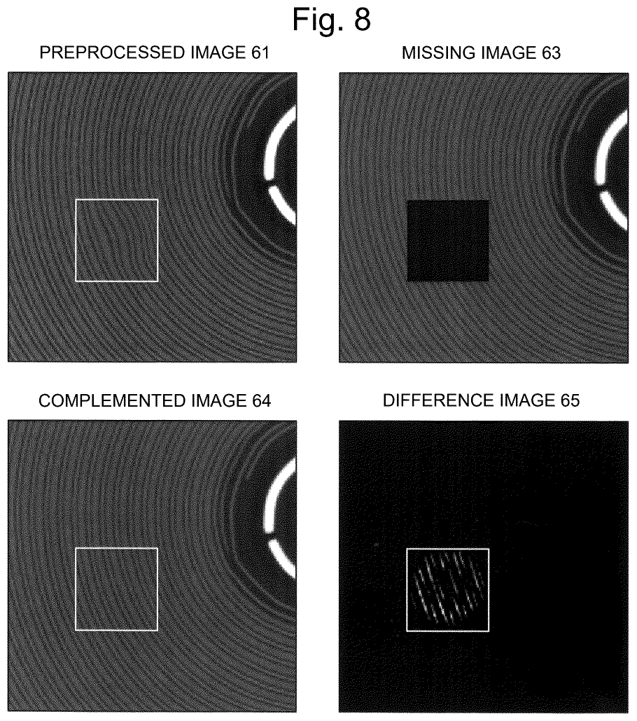

FIG. 8 shows a preprocessed image 61, missing image 63, complemented image 64 and difference image 65 related to one window in which an abnormality was detected. As described earlier, the image generator in the present embodiment is built by machine learning for generating, from an image having a partially missing region, an image in which the missing region has been filled with a complementary image. Therefore, a region including the abnormal portion (the region at which the window is set) is removed from the preprocessed image 61, and a complemented image 64 in which the missing region has been filled with a complementary image is generated by the image generator, whereby the missing region is filled with a complementary image of normal electrodes. Accordingly, if the region to which the window is applied is normal, no significant difference occurs between the preprocessed image 61 and the complemented image 64. Conversely, when an abnormality is included in the window-applied region, a significant difference occurs between the preprocessed image 61 and the complemented image 64. Consequently, as shown by the partial enlarged view in FIG. 8, and a variation in pixel value occurs among the pixels in the difference image 65 of the two aforementioned images. Therefore, by calculating the standard deviation representing the variation in pixel value of the pixels within the window-applied region of the difference image 65 and comparing the calculated value with a previously determined threshold, it is possible to determine whether or not an abnormality is included within the region concerned.

### SECOND EXAMPLE

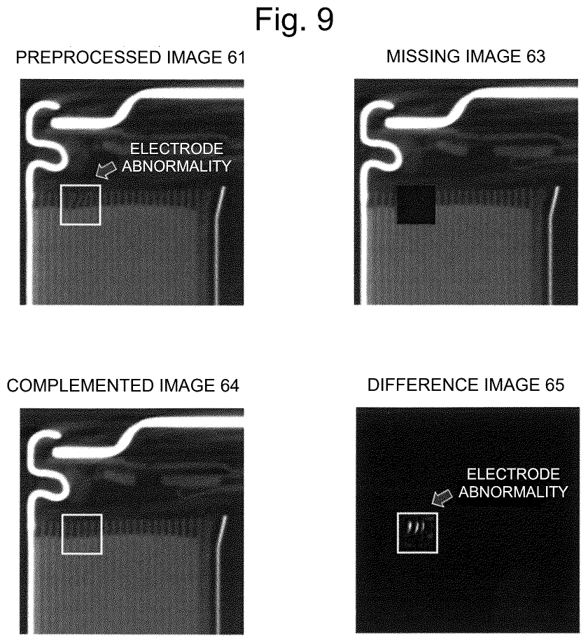

FIG. 9 shows an example of the result of an inspection in which, similar to the first example, a cylindrical lithium-ion battery was tested for the presence or absence of an abnormality of the electrodes before and after a repetitive charge-and-discharge test. As opposed to the first example which showed the result of an inspection in which tomographic images at a horizontal section (i.e., a section orthogonal to the extending direction of the electrodes) of the lithium-ion battery were used, the second example shows the result of an inspection in which tomographic images at a vertical section (i.e., a section parallel to the extending direction of the electrodes and containing the central axis of the rolled electrodes) of the lithium-ion battery were used. The second example also demonstrates that the location at which an abnormality of the electrodes has occurred is clearly visible in the difference image, which has resulted in a significant variation in the pixel value of the pixels concerned (the standard deviation is large).

Thus, in the present embodiment and examples, a complemented image is generated by an image generator trained by machine learning for generating an image of a normal object (preferably, an inspection target object). The subsequent determination on normality or abnormality is performed by the simple process of calculating the standard deviation of the pixel values in a difference image of a preprocessed image (original image) and the complemented image. Therefore, unlike the conventional technique in which a discriminator for discriminating between normality and abnormality of an inspection target object is built by machine learning, it is unnecessary to use a large number of images of inspection target objects including abnormalities occurring in a wide variety of modes, so that the amount of time, labor and cost for determining the normality or abnormality of an inspection target object can be reduced as compared to the conventional case.

The previously described embodiment and examples are mere examples and can be appropriately changed or modified without departing from the spirit of the present invention.

In the previously described embodiment, tomographic images of an inspection target object (e.g., storage battery) are acquired with the X-ray CT apparatus 10 and whether the electrodes of the storage battery are normal or abnormal is determined based on those tomographic images. Actually, the kind of inspection target image may be appropriately selected; an appropriate kind of image can be used according to the purpose of the inspection. For example, in the case of an appearance test, images showing an appearance of the inspection target object can be used. The inspection target object is not limited to storage batteries or similar solid objects. There are various types of images that can be used as inspection target images, such as an image of human tissue (organ) taken with the X-ray CT apparatus 10 or an image showing the distribution of a target compound in a sample taken with an imaging mass spectrometer.

The previously described embodiment dealt with an example in which a plurality of images were taken by dual energy imaging in order to remove artefacts from the images. Other imaging techniques, such as a photon-counting CT or phase imaging, may also be used according to the properties of the inspection target object to acquire images, identify the composition of the inspection target object and locate the site to be inspected.

In the previously described embodiment and examples, the standard deviation calculated for the difference image of a region on which the window was set was compared with the threshold to determine the normality or abnormality of the window-set region. The determination on the normality or abnormality of the region concerned may be based on any quantity representing a feature of the difference image of that region (feature quantity); a quantity different from the standard deviation may also be used. For example, a mean, variance, eigenvalue or representative value of norm of the pixel values at the pixels within the difference image of the window-set region may be used. Color images of the inspection target object may be used as the basis for determining the normality or abnormality of the object, as opposed to the previously described embodiment and examples in which monochrome images were used. In the case of using color images, RGB values may be used as pixel values.

The previously described embodiment and examples were concerned with the case where the image generator generates a difference image using a single complemented image for each missing image. In many cases, an image generator built by machine learning (a so-called “generative AI”) is configured to generate a plurality of images with their respective degrees of certainty and present an image having the highest degree of certainty as the generated image. In the previously described embodiment, the single complemented image presented by the image generator was used for generating the difference image. However, the determination of the degree of certainty by the image generator is not always correct. For example, in the case of generating a complemented image 64 from a missing image 63 prepared by removing a peripheral portion of a preprocessed image 61 or a portion of an image of an inspection target object which shows a low degree of periodicity, the complemented image 64 generated by the image generator may have a low level of accuracy, and accordingly, a low degree of certainty. In such a case, a difference image 65 may be created for each of all complemented images 64 generated by the image generator (or a predetermined number of complemented images 64 selected in descending order of the degree of certainty), and a feature quantity calculated from those difference images 65 (e.g., the standard deviation in the previously described embodiment and examples) may be used as a basis for determining normality or abnormality. By this method, an abnormality can be more assuredly detected in the case where it is difficult to generate a complemented image with a high level of accuracy by the image generator.

Although a window having a fixed size was used in the previously described embodiment, a plurality of windows of different sizes may also be used. For example, when an abnormal portion in the inspection target object is small, applying a large window to the abnormal portion results in a situation in which pixel values that indicate abnormality only occur at an extremely small number of pixels within the window, with the other pixels showing no significant differences and preventing the value of the standard deviation from exceeding the threshold. In such a case, a plurality of windows of different sizes may be used so that an abnormal portion of a given size can be detected through a window whose size is suited for the size of that abnormal portion.

In the previously described embodiment, the window was sequentially set at a plurality of different positions so that the new window partially overlaps the previous window. If the location at which an abnormality occurs in the inspection target object is previously known, the window may be set only at that location.

In the previously described embodiment, an image generator created by a generative adversarial network was used. Other techniques are also available for creating image generators, and an image generator created by any one of those techniques may also be used. For example, an image generator created by a diffusion model, VAE (variational autoencoder), flow-based model, self-regression model or the like as described in Non Patent Literature 3 may be used.

### Modes

It is evident to a person skilled in the art that the previously described illustrative embodiment is a specific example of the following modes of the present invention.

### Clause 1

An inspection method according to one mode of the present invention includes:
an image generator preparation process for preparing an image generator by machine learning, the image generator configured to generate, from an image having a partially missing region, an image in which the missing region is filled with a complementary image;
an inspection-image preparation process for preparing an inspection target image;
a missing-image generation process for specifying a window having a previously determined shape and size, and for generating, from the inspection target image, a missing image in which a region is missing, the window being applied on the region;
a complemented-image generation process for generating a complemented image in which the region is filled with a complementary image by inputting the missing image into the image generator;
a difference acquisition process for determining a difference between the inspection target image and the complemented image; and
a determination process for determining whether the region is normal or abnormal by comparing the difference with a previously determined criterion.

### Clause 2

An inspection device according to Clause 2 includes:
an image-generator storage section in which an image generator built by machine learning is stored, the image generator configured to generate, from an image having a partially missing region, an image in which the missing region is filled with a complementary image;
an image storage section in which an inspection target image is stored;
a missing-image generator configured to generate, from the inspection target image, a missing image in which a region is missing, a window having a previously specified shape and size being applied on the region;
a complemented-image generator configured to generate a complemented image in which the region is filled with a complementary image by inputting the missing image into the image generator;
a difference acquirer configured to determine a difference between the inspection target image and the complemented image; and
a determiner configured to determine whether the region is normal or abnormal by comparing the difference with a previously determined criterion.

### Clause 3

In the inspection device according to Clause 3, which is one mode of the inspection device according to Clause 2, the image generator consists of a generator used with a discriminator in adversarial learning.

In the inspection method according to Clause 1 and the inspection device according to Clause 2, an image generator configured to generate, from an image having a partially missing region, an image in which the missing region is filled with a complementary image is prepared beforehand by machine learning. For example, an image generator consisting of a generator used with a discriminator in adversarial learning, as used in the inspection device according to Clause 3, may be used as the aforementioned image generator. The image generator used in the inspection method according to Clause 1 and the inspection device according to Clause 2 is a so-called image generative AI and has the function of filling a missing region in an image by an appropriate method, e.g., by deducing a normal image to be included in the missing region from an image of a surrounding area of the missing region. This image generator is built by machine learning using images of normal objects (preferably, inspection target objects) and fills the missing region of an inspection target image with an image of a normal object (inspection target object).

In the inspection method according to Clause 1 and the inspection device according to Clause 2, a window having a previously determined shape and size is specified, and the window is applied to an image of an inspection target object (inspection target image) and its inner region is removed. An image for filling that removed region (missing region) is created by the image generator. As noted earlier, the image generator fills the missing region with a complementary image of a normal inspection target object. Therefore, no significant difference occurs between the inspection target image and the complemented image if the inspection target image is an image of a normal inspection target object. Conversely, when an abnormality is included within the window-applied region of the inspection target image, a significant difference occurs in that region when a difference between the inspection target image and the complemented image (e.g., the difference of each pixel value) is determined. By extracting such a significant difference based on the previously determined criterion, it is concluded that an abnormality is included within the window-applied region.

Conventional techniques employ a discriminator in order to determine whether or not an abnormality is included in an inspection target image. Therefore, in order to discriminate between normality and abnormality of an inspection target object with a high level of accuracy, it is necessary to perform machine learning using, as training data, a huge number of images of inspection target objects including various modes of abnormalities. By comparison, the inspection method according to Clause 1 and the inspection device according to Clause 2 employ an image generator which fills a missing region within a window applied to an inspection target image with an image of a normal inspection target. Whether or not an abnormality is included in the inspection target image is determined by a simple process in which the difference between pixel values of the inspection target image and the corresponding pixel values of the complemented image is compared with a previously determined criterion. This process does not require a discriminator. In the inspection method according to Clause 1 and the inspection device according to Clause 2, an image generator built by machine learning using images of normal inspection target objects can be used. As compared to the discriminator conventionally used for discriminating between normality and abnormality of an inspection target object based on an image of the same object, the aforementioned image generator can be built with a smaller amount of time, labor and cost and yet enables the determination on whether the inspection target object is normal or abnormal.

### Clause 4

In the inspection device according to Clause 4, which is one mode of the inspection device according to Clause 2 or 3, the missing-image generator is configured to sequentially set the window at a plurality of different positions in the inspection target image so that the new window partially overlaps the previous window.

The inspection device according to Clause 4 can detect an abnormality at any position in the image of the inspection target object based on a difference obtained when the window is applied to that position, regardless of which portion of the image the abnormality belongs to.

### Clause 5

In the inspection device according to Clause 5, which is one mode of the inspection device according to one of Clauses 2-4:
the complemented-image generator is configured to generate a plurality of complemented images for one image which is the missing image; and
the difference acquirer is configured to determine a difference between the inspection target image and each of the plurality of complemented images.

For example, in the case of generating a complemented image from a missing image prepared by removing a peripheral portion of an inspection target image or a portion of an image of an inspection target object which shows a low degree of periodicity, the complemented image generated by the image generator may have a low level of accuracy. In the inspection device according to Clause 5, since the difference is determined for each of the plurality of complemented images generated by the image generator, an abnormality can be more assuredly detected in the case where it is difficult to generate a complemented image with a high level of accuracy by the image generator.

### REFERENCE SIGNS LIST

1 . . . Inspection System
10 . . . X-Ray CT Apparatus
20 . . . Control-and-Processing Device
30 . . . Storage Unit
31 . . . Image-generator storage Section
32 . . . Image Storage Section
40 . . . Inspection Software
41 . . . Imaging Controller
42 . . . Image Preprocessor
43 . . . Window Setter
44 . . . Missing-image generator
45 . . . Complemented-image generator
46 . . . Difference Image Acquirer
47 . . . Determiner
48 . . . Inspection Result Display Processor
51 . . . Input Unit
52 . . . Display Unit
61 . . . Preprocessed Image
62 . . . Window
63 . . . Missing Image
64 . . . Complemented Image
65 . . . Difference Image

1. An inspection method, comprising:
an image generator preparation process for preparing an image generator by machine learning, the image generator configured to generate, from an image having a partially missing region, an image in which the missing region is filled with a complementary image;
an inspection-image preparation process for preparing an inspection target image;
a missing-image generation process for specifying a window having a previously determined shape and size, and for generating, from the inspection target image, a missing image in which a region is missing, the window being applied on the region;
a complemented-image generation process for generating a complemented image in which the region is filled with a complementary image by inputting the missing image into the image generator;
a difference acquisition process for determining a difference between the inspection target image and the complemented image; and
a determination process for determining whether the region is normal or abnormal by comparing the difference with a previously determined criterion.

2. An inspection device, comprising:
an image-generator storage section in which an image generator built by machine learning is stored, the image generator configured to generate, from an image having a partially missing region, an image in which the missing region is filled with a complementary image;
an image storage section in which an inspection target image is stored;
a missing-image generator configured to generate, from the inspection target image, a missing image in which a region is missing, a window having a previously specified shape and size being applied on the region;
a complemented-image generator configured to generate a complemented image in which the region is filled with a complementary image by inputting the missing image into the image generator;
a difference acquirer configured to determine a difference between the inspection target image and the complemented image; and
a determiner configured to determine whether the region is normal or abnormal by comparing the difference with a previously determined criterion.

3. The inspection device according to claim 2, wherein the image generator consists of a generator used with a discriminator in adversarial learning.

4. The inspection device according to claim 2, wherein the missing-image generator is configured to sequentially set the window at a plurality of different positions in the inspection target image so that the new window partially overlaps the previous window.

5. The inspection device according to claim 2, wherein:
the complemented-image generator is configured to generate a plurality of complemented images for one image which is the missing image; and
the difference acquirer is configured to determine a difference between the inspection target image and each of the plurality of complemented images.
